(19) United States
(12) Patent Application Publication
(10) Pub. No.: US 2009/0132201 A1
(43) Pub. Date: May 21, 2009

(54) Method and apparatus for measuring performance of a periodically changing system accomplishing a task

(76) Inventor: Horst Erhard Kunig, Saltsburg, PA (US)

Correspondence Address: Horst Erhard Kunig, P.O. Box 192, Saltsburg, PA, 15681-0192, US

(21) Appl. No.: 12/290,103

(22) Filed: Oct. 27, 2008

Related U.S. Application Data
(63) Continuation-in-part of application No. 11/342,151, filed on Jan. 27, 2006.

(51) Int. Cl. G06F 15/00

(52) U.S. Cl. 702/182

(57) ABSTRACT

A device is disclosed to determine performance of a periodically changing system, to generate a performance diagram and to measure and display performance in said. The device further measures sufficiency, efficiency, and effectiveness, sufficiency reserves, efficiency reserves, and effectiveness reserves of the system during performance of tasks by comparison with sufficiency reference frames, efficiency reference framers and effectiveness reference frames, said frames determining the operating range for further determination of deterioration and/or improvement of the system from the time changes of the reserves. The method and device have utility to determine the need for intervention, to design and monitor interventions for improvement of the system.

### CROSS REFERENCE TO RELATED APPLICATION

The application is a continuation-in-part of application Ser. No. 11/342,151 filed on Jan. 27, 2006 and abandoned

### FIELD OF THE INVENTION

The present invention relates to the performance of a system periodically changing in time and, more specifically, to a method and apparatus for determining sufficiency, efficiency, reserves and effectiveness operating range, and operating point of the system during operation to perform a task.

### DESCRIPTION OF PRIOR ART

For a periodically changing system performance is usually inferred by the capability of the system to effectuate a task. Absent is the relationship of performance with the sufficiency of the resources available for accomplishment of the task, the efficiency with which the resources are utilized, and a quantitative delineation of the task, said sufficiency and efficiency determining the operating range, OR, operating point, OP, the effectiveness and the reserves of the system to accomplish the task.

Performance is also related to maximal and minimal values of the periodically changing parameters during one cycle and to empirically derived surrogate ranges of normalcy. The empiricism associated with the surrogate range of normalcy of operation provides for ambiguous performance determinations. More specifically, absent are a lower limit minimal reference frame, below which the system is unable to perform a task, and an upper limit maximal reference frame, above which the system also fails to perform, because it is no longer capable. The range between lower limit minimal reference frame and upper limit maximal reference frame delineates the range of operation, OR, in which the system is capable to perform the task. The difference between measured performance at an operating point, OP, comprising sufficiency, efficiency, reserves, and effectiveness, and minimal and maximal reference frames of these parameters is indicative of the reserve of the system and the capability to accomplish the task.

Disclosed in U.S. Pat. No. 6,529,917 is a method to establish the synergy of several parameters from which to determine quantitatively functionality. This disclosure describes deterioration of the system be divergence from a minimal reference frame, but fails to delineate with specificity the conditions at which functionality ceases.

It is therefore an object of the present invention to provide means for determination of the operating range, operating point, performance, effectiveness, deterioration, and improvement of the system and its suitability for a particular task.

It is also an object of the present invention to provide minimal and maximal reference frames below and above which the system fails to perform to accomplish a particular task.

It is a further objective of the present invention at the operating point to compare measured sufficiency, efficiency, and effectiveness with minimal and maximal reference frames, delineating the operating range, to allow determination of respective reserves.

It is a further objective of the present invention to determine deterioration and improvement from the change of the respective reserves in time.

It is still another object of the present invention to monitor performance, comprising sufficiency, efficiency, and effectiveness, to commence interventions upon approaching minimal and maximal reference frames to improve performance to accomplish a particular task, and to monitor the benefits of the interventions.

### SUMMARY OF THE PRESENT INVENTION

According to the present invention, there is provided a device and a method for quantitative determination of the operating range of the system, its performance, comprising sufficiency, efficiency, and effectiveness in relation to the accomplishment of a particular task. There are further provided minimal and maximal sufficiency, efficiency, and effectiveness reference frames, related to the task the system must perform, for comparison with the measured sufficiency, efficiency, and effectiveness data. Still further, there are provided means for determining the difference between measured sufficiency, efficiency, and effectiveness data and respective minimal and maximal reference frames, said difference being used to determine sufficiency reserves, efficiency reserves, and effectiveness reserves of the system and the selection of the optimal operating point of the system to accomplish a particular task. Further means are provided to determine deterioration from diminishing sufficiency reserves, efficiency reserves, and effectiveness reserves over time and improvements from increasing said reserves over time.

The device includes the combination of sensors responsive to operational purpose information, as provided for accomplishment of a task, and sensors responsive to parameters of a system periodically changing in time, collectively referred to as A, at an initial time t₁, denoted, A₁, and at a subsequent time t₂, denoted A₂, means to transmit A to a computer for computing the magnitudes of A at various times, the difference of the magnitudes of A at various times, the ratio of the change of A at various times in relation to the magnitude of A at an initial time, denoting efficiency, the ratio of the change of A to the time in which the change occurred, denoting sufficiency, and the ratio of sufficiency to efficiency, denoting effectiveness. The computer further includes sensors responsive to pre-selected minimal and maximal magnitudes of A, said minimal and maximal magnitudes comprising the minimal and maximal reference frames for delineation of the operating range, and the selection of the optimal operating point of the system to accomplish a task. The computer further includes means for comparison of instant sufficiency, efficiency, and effectiveness data at the operating point with operational task information, and the minimal and maximal reference frames to delineate the operating range of the system for determination of reserves and means for determining the change of the reserves with time and means for determining deterioration and improvement from said reserve changes in time. The device further provides means for determining the optimal operating point of the system for accomplishing a task, for determining the need for interventions and monitoring the effects of the interventions, depending on the changes of the respective reserves, means representative of the task to be performed by the system, including means to indicate attainment or failure of the task, and recording means, audible and visible warning means, activated upon the establishment of pre-selected values to warn of impending breakdown and modems for transmission to a central storage facility.

### BRIEF DESCRIPTION OF THE DRAWINGS

The present invention will be more fully understood, when the following detailed description is read in conjunction with the accompanying drawings in which:

FIG. 1 illustrates the change of a parameter A with time t, said parameter A to include but not limited to electrical, magnetic, mechanical, volume, area, pressure, optical, acoustic, thermal, transcendental parameters, further including quantity of things, their monetary value, sales, expenses, profit, also chemical parameters, further including oxygen concentration, oxygen consumption, also temperature, time, signals, frequency, heart rate, body surface area, and body mass index, and still further combinations thereof, further including energy, work, and impedance, said parameters and signals collectively referred to as signals A,:

FIG. 2 illustrates the utility of the instant invention in a performance diagram to determine the operating range of the system, inscribed in the maximal and minimal reference frames, and in which data points P and Q are operating points within the operating range at different times, further illustrating sufficiency, insufficiency, efficiency, inefficiency, respective reserves thereof, changes of the respective reserves in time, and deterioration and improvement of the system;

FIG. 3 shows a block diagram of the apparatus to practice the instant invention;

FIG. 4 shows a performance diagram to determine the range of operation, OR, and point of operation, OP, of the cardiocirculatory system, sufficiency, efficiency, deterioration and improvement with changing task requirements during a graduated exercise test, according to the instant invention;

FIG. 5 is a parametric display of the performance diagram to determine in greater detail sufficiency, sufficiency reserves, efficiency, and efficiency reserves in time of the cardiocirculatory system during a graduated exercise test, according to the instant invention for further use of selection of point of operation in wellness, safe exercise, and health improvement programs. Horizontal lines denote maximal and minimal reference frames, above and below which efficiency and sufficiency reserves vanish and inefficiency and insufficiency occurs;

FIG. 6 is a parametric display of performance during a graduated exercise test in the performance diagram to determine in greater detail effectiveness, ineffectiveness, and effectiveness reserves in time of the cardiocirculatory system, according to the instant invention for further use of selecting a point of operation in wellness, safe exercise, and health improvement programs in relation to changing task requirements.

### DETAILED DESCRIPTION OF THE PREFERRED EMBODIMENT

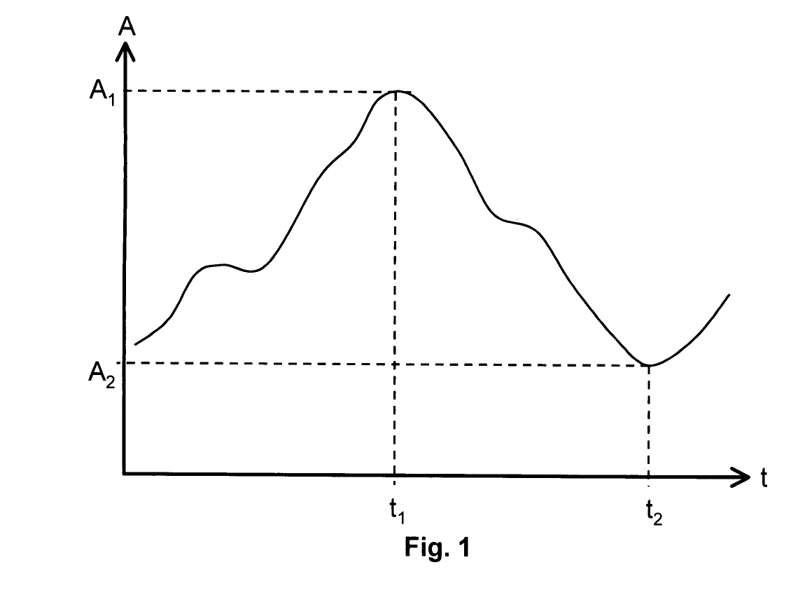

Referring now to FIG. 1, signals A are measured as a function of time, t. The magnitudes of signals A at specific times describe the state of the system at these instant times, but do not describe performance.

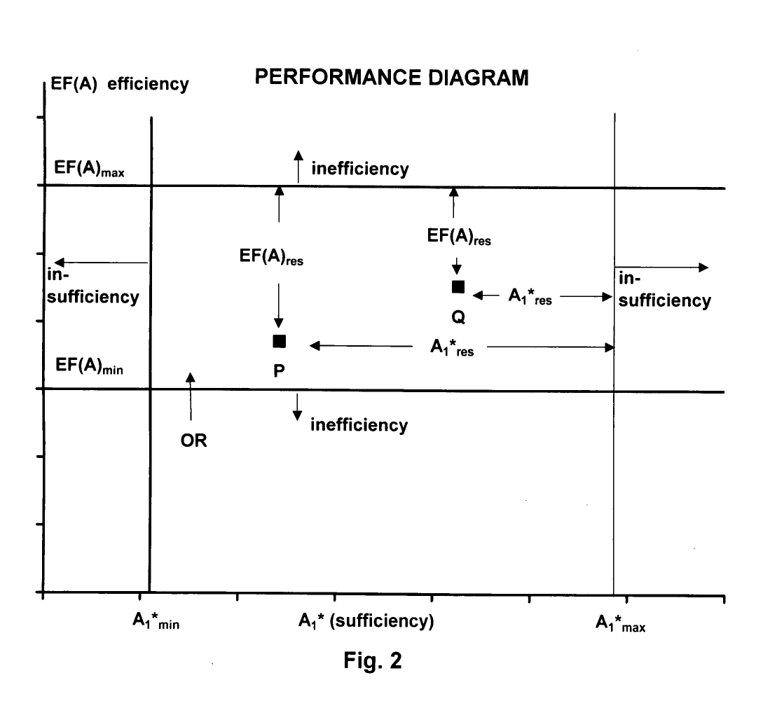

Referring now to FIG. 2, performance of the system is defined as the execution of an action to accomplish a task. As the execution of an action, requires time during which the magnitude of signals A change, performance is determined by the change of A, denoted AA, and given by AA=A₁−A₂, during the time t₂−t₁,

AA/(t₂−t₁)=(A₁−A₂)/(t₂−t₁) or

AA*=A₁*−A₂* (1)

Where AA*=AA/(t₂−t₁), A₁*=A₁/(t₂−t₁), and
A₂*=A₂/(t₂−t₁). The frequency, f, of the periodically changing system, being equal to 1/(t₂−t₁), may be substituted for the reciprocal of (t₂−t₁). Expanding the right side of equation (1) by the ratio of A₁*/A₁* yields

AA*=(A₁*−A₂*)×(A₁*/A₁*) or

AA*=EF(A)×A₁* (2)

Defined as performance equation, where

EF(A)=(A₁*−A₂*)/A₁* (3)

is the ejection fraction. EF(A) denotes the efficiency of the system. Performance equation (2) describes how efficiently (EF(A)) a resource (A₁*) of sufficient magnitude is maintained and used by the system to perform and accomplished a task. Thus A₁* denotes sufficiency of the system.

Efficiency, represented by EF(A) of equation (3), is plotted versus sufficiency, represented by A₁*, said plot being identified by the instant invention as performance diagram. Minimal reference frames EF(A)ₘᵢₙ and A₁*ₘᵢₙ and maximal reference frames EF(A)ₘₐₓ and A₁*ₘₐₓ are provided in the performance diagram. The points in the performance diagram having coordinates (A₁*ₘᵢₙ/EF(A)ₘᵢₙ), (A₁*ₘₐₓ/EF(A)ₘᵢₙ), (A₁*ₘₐₓ/EF(A)ₘₐₓ), and (A₁*ₘᵢₙ/EF(A)ₘₐₓ), delineate a rectangle, said minimal and maximal reference frames of the rectangle further delineating the operating range, OR, given by

OR=(A₁*ₘₐₓ−A₁*ₘᵢₙ)×(EF(A)ₘₐₓ−EF(A)ₘᵢₙ) (4)

The system performs, if the measured values A₁* and EF(A), said values denoting the operating point, fall within the rectangle, that is, within the operating range and fails to perform, if the measured values A₁* and EF(A) fall outside the operating range of the rectangle. More specifically, A₁*ₘᵢₙ<A₁*<A₁*ₘₐₓ and EF(A)ₘᵢₙ<EF(A)<EF(A)ₘₐₓ denote the area of performance, and A₁*<A₁*ₘᵢₙ and A₁*>A₁*ₘₐₓ denote the area of insufficiency and still further EF(A)<EF(A)ₘᵢₙ and EF(A)>EF(A)ₘₐₓ denote the area of inefficiency. The difference A₁*ₘₐₓ and A₁* measures the sufficiency reserves, A₁*ᵣₑₛ, and the difference EF(A)ₘₐₓ and EF(A) measures the efficiency reserves, EF(A)ᵣₑₛ.

EF(A)ᵣₑₛ=EF(A)ₘₐₓ−EF(A) (5)

A₁*ᵣₑₛ=A₁*ₘₐₓ−A₁* (6)

Both reserves may be referenced to maximal values EF(A)ₘₐₓ and A₁*ₘₐₓ and expressed as % of the maximal magnitudes and are given by

EF(A)ᵣₑₛ/EF(A)ₘₐₓ=(EF(A)ₘₐₓ−EF(A))/EF(A)ₘₐₓ (7)

A₁*ᵣₑₛ/A₁*ₘₐₓ=(A₁*ₘₐₓ−A₁*)/A₁*ₘₐₓ (8)

Further the instant invention teaches, that diminishing sufficiency reserves A₁*ᵣₑₛ and/or efficiency reserves EF(A)ᵣₑₛ in time denote deterioration and increasing reserves improvement. If measurement P, denoting an operating point taken at time t₁, and measurement Q, denoting a operating point taken at time t₂, then efficiency and sufficiency reserves diminish between the two measurements, indicating deteriorating performance, and vice versa.

Still further, according to the instant invention, the ratio of A₁* to EF(A), denotes the effectiveness of the system performing a task, said effectiveness being abbreviated by EFF(A). and given by

EFF(A)=A₁*/EF(A) (9)

The difference between maximal effectiveness, EFF(A)ₘₐₓ and measured effectiveness EFF(A) indicates the effectiveness reserves EFF(A)ᵣₑₛ, given by

EFF(A)ᵣₑₛ=(EFF(A)ₘₐₓ−EFF)A))/EFF(A)ₘₐₓ (10)

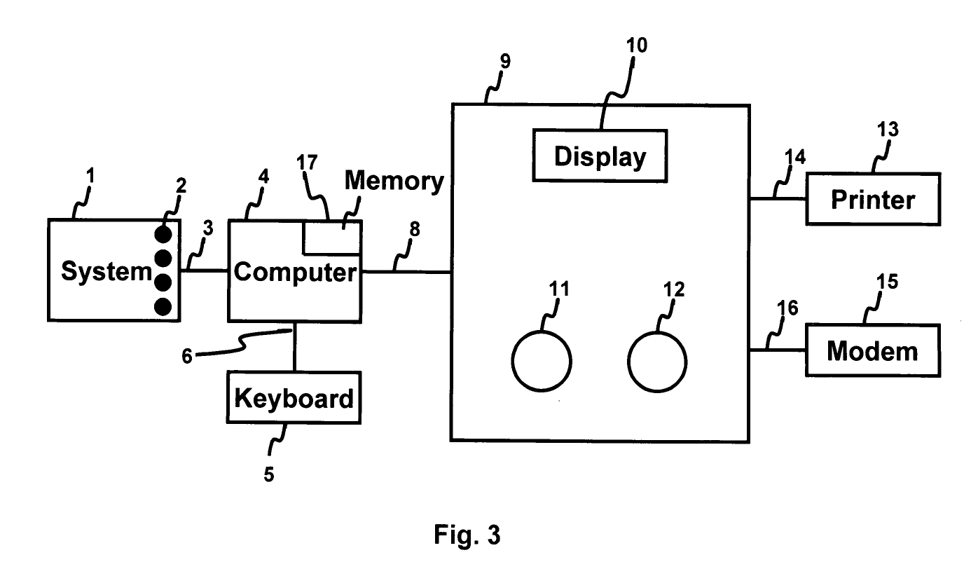

The embodiment, as shown in FIG. 3, illustrates the teachings of the instant invention. Accordingly, sensors 2 are placed on a system 1, to detect signals representative of signals A to include but not limited to electrical, magnetic, mechanical, volume, area, pressure, optical, acoustic, thermal, transcendental parameters, further including quantity of things, their monetary value, sales, expenses, profit, also chemical parameters, further including oxygen concentration, oxygen consumption, also temperature, time, signals, frequency, heart rate, body surface area, and body mass index, and still further combinations thereof, further including energy, work, and impedance, said parameters and signals collectively referred to as signals A, which are transmitted on multi-line wire 3 to computer 4. Such sensors 2 may include appropriate apparatus sensitive to the signals. Additional input representative of system information including nature of the system, weight, height, body surface area, pre-selected time intervals, and pre-selected minimal and maximal reference frames, and task to be accomplished is provided from a keyboard 5 to computer 4 on line 6. Computer 4 is programmed to process the incoming signals on line 6 to establish reference frames A₁*ₘᵢₙ, A₁*ₘₐₓ, EF(A)ₘᵢₙ, and EF(A)ₘₐₓ for determining zones of sufficiency, insufficiency, efficiency, inefficiency, effectiveness, ineffectiveness, range of operation, and point of operation. Computer 4 is also programmed to process the incoming signals on line 3, to determine their magnitudes, the changes of the magnitudes in relation to an initial magnitude and to the time in which the changes occurred to construct a performance diagram, and to compare measured data A₁* and EF(A), entered in the performance diagram with minimal and maximal reference frames A₁*ₘᵢₙ, A₁*ₘₐₓ, EF(A)ₘᵢₙ, and EF(A)ₘₐₓ, for further determination of range of operation, selection of operating point OP, sufficiency A₁*, sufficiency reserves A₁*ᵣₑₛ, efficiency EF(A), efficiency reserves (EF(A)ᵣₑₛ, effectiveness EFF(A), and effectiveness reserves EFF(A)ᵣₑₛ. Computer 4 also determines the need for interventions upon attainment of pre-determined values of sufficiency reserves A₁*ᵣₑₛ, efficiency reserves EF(A)ᵣₑₛ, effectiveness reserves EFF(A)ᵣₑₛ and to monitor the benefits of interventions by monitoring the changes of A₁*ᵣₑₛ, EF(A)ᵣₑₛ, and effectiveness reserves A₁*ᵣₑₛ/EF(A)ᵣₑₛ, caused by the intervention, indicative of deteriorating or improving performance. All parameters, representative of said performance, are transmitted by line 8 to a monitor 9 which is comprised of a display 10, audible and visual alarms 11 to warn of emergencies if preset values of the parameters are attained, and indicators 12 to display the performance diagram, minimal and maximal reference frames, sufficiency, efficiency, effectiveness, and respective reserves, and deteriorating and improving performance. The signals displayed by display 10 and the audio and visual alarms 11 and the signals displayed by indicator 12 are transmitted on line 14 to a printer 13 for producing hard copies and on line 16 to a modem 15 for transmission to central storage and retrieval. A memory 17 in computer 4 serves as storage of all information and data.

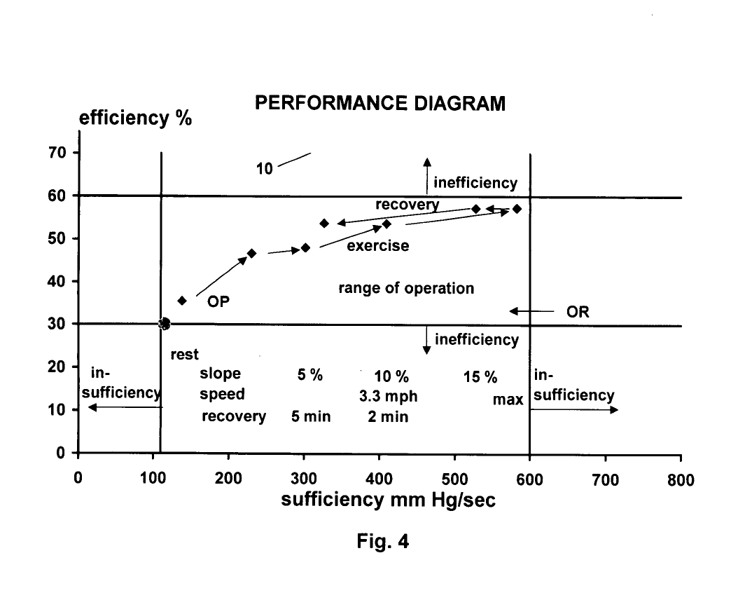

Referring now to FIG. 4, there is displayed a performance diagram generated from data as published by R. A. Wolthuis et al. in an article, entitled, The response of healthy men to treadmill exercise, Circulation 1977; 55:153-157, which are summarized in Table 1. Here the system is comprised of the cardiocirculatory system, the signal A is the arterial blood pressure, A₁ is the systolic blood pressure SBP, A₂ is the diastolic pressure, DBP, and the frequency f is the heart rate, HR. Measurements, displayed in the performance diagram, were taken at rest, at three sub-maximal exercise stages of increasing intensities (stage 1: speed 3.3 mph, slope 5%; stage 2: speed 3.3 mph, slope 10%; stage 3: speed 3.3 mph, slope 15%), at maximal intensity, and at two subsequent times (2 minutes and 5 minutes) during recovery, said measurements indicating the operating points at various exercise intensities during a graduated exercise test.

TABLE 1

| SBP | 124 mmHg | rest |
|---|---|---|
| SBP | 152 mmHg | stage 1: speed 3.3 mph slope 5% |
| SBP | 166 mmHg | stage 2: speed 3.3 mph slope 10% |
| SBP | 180 mmHg | stage 3: speed 3.3 mph slope 15% |
| SBP | 188 mmHg | maximal exertion |
| SBP | 162 mmHg | recovery 2 minutes |
| SBP | 135 mmHg | recovery 5 minutes |
| DBP | 80 mmHg | rest |
| DBP | 79 mmHg | stage 1: speed 3.3 mph slope 5% |
| DBP | 77 mmHg | stage 2: speed 3.3 mph slope 10% |
| DBP | 77 mmHg | stage 3: speed 3.3 mph slope 15% |
| DBP | 79 mmHg | maximal exertion |
| DBP | 75 mmHg | recovery 2 minutes |
| DBP | 72 mmHg | recovery 5 minutes |
| HR | 67 1/min | rest |
| HR | 119 1/min | stage 1: speed 3.3 mph slope 5% |
| HR | 148 1/min | stage 2: speed 3.3 mph slope 10% |
| HR | 176 1/min | stage 3: speed 3.3 mph slope 15% |
| HR | 189 1/min | maximal exertion |
| HR | 121 1/min | recovery 2 minutes |
| HR | 102 1/min | recovery 5 minutes |
| EF(P) | 35% | rest |
| EF(P) | 48% | stage 1: speed 3.3 mph slope 5% |
| EF(P) | 54% | stage 2: speed 3.3 mph slope 10% |
| EF(P) | 57% | stage 3: speed 3.3 mph slope 15% |
| EF(P) | 58% | maximal exertion |
| EF(P) | 54% | recovery 2 minutes |
| EF(P) | 47% | recovery 5 minutes |
| EF(P)ᵣₑₛ/EF(P)ₘₐₓ | 41% | rest |
| EF(P)ᵣₑₛ/EF(P)ₘₐₓ | 20% | stage 1: speed 3.3 mph slope 5% |
| EF(P)ᵣₑₛ/EF(P)ₘₐₓ | 11% | stage 2: speed 3.3 mph slope 10% |
| EF(P)ᵣₑₛ/EF(P)ₘₐₓ | 5% | stage 3: speed 3.3 mph slope 15% |
| EF(P)ᵣₑₛ/EF(P)ₘₐₓ | 3% | maximal exertion |
| EF(P)ᵣₑₛ/EF(P)ₘₐₓ | 10% | recovery stage 1, 2 minutes |
| EF(P)ᵣₑₛ/EF(P)ₘₐₓ | 22% | recovery stage 2, 5 minutes |
| SBP* | 138 mmHg/sec | rest |
| SBP* | 301 mmHg/sec | stage 1: speed 3.3 mph slope 5% |
| SBP* | 409 mmHg/sec | stage 2: speed 3.3 mph slope 10% |
| SBP* | 528 mmHg/sec | stage 3: speed 3.3 mph slope 15% |
| SBP* | 592 mmHg/sec | maximal exertion |
| SBP* | 327 mmHg/sec | recovery 2 minutes |
| SBP* | 230 mmHg/sec | recovery 5 minutes |
| SBP*ᵣₑₛ/SBP*ₘₐₓ | 77% | rest |
| SBP*ᵣₑₛ/SBP*ₘₐₓ | 50% | stage 1: speed 3.3 mph slope 5% |
| SBP*ᵣₑₛ/SBP*ₘₐₓ | 32% | stage 2: speed 3.3 mph slope 15% |
| SBP*ᵣₑₛ/SBP*ₘₐₓ | 12% | stage 3: speed 3.3 mph slope 15% |
| SBP*ᵣₑₛ/SBP*ₘₐₓ | 1% | maximal exertion |
| SBP*ᵣₑₛ/SBP*ₘₐₓ | 46% | recovery 2 minutes |
| SBP*ᵣₑₛ/SBP*ₘₐₓ | 62% | recovery 5 minutes |
| EFF(P) | 3.90 mmHg/sec | rest |
| EFF(P) | 6.28 mmHg/sec | stage 1: speed 3.3 mph slope 5% |
| EFF(P) | 7.64 mmHg/sec | stage 2: speed 3.3 mph slope 10% |
| EFF(P) | 9.23 mmHg/sec | stage 3: speed 3.3 mph slope 15% |
| EFF(P) | 10.21 mmHg/ | maximal exertion |
| | sec | |
| EFF(P) | 6.08 mmHg/sec | recovery 2 minutes |
| EFF(P) | 4.92 mmHg/sec | recovery 5 minutes |
| EFF(P)ᵣₑₛ | 3.90 mmHg/sec | rest |
| EFF(P)ᵣₑₛ | 6.28 mmHg/sec | stage 1: speed 3.3 mph slope 5% |
| EFF(P)ᵣₑₛ | 7.64 mmHg/sec | stage 2: speed 3.3 mph slope 10% |
| EFF(P)ᵣₑₛ | 9.23 mmHg/sec | stage 3: speed 3.3 mph slope 15% |
| EFF(P)ᵣₑₛ | 10.21 mmHg/ | maximal exertion |
| | sec | |
| EFF(P)ᵣₑₛ | 6.08 mmHg/sec | recovery 2 minutes |
| EFF(P)ᵣₑₛ | 4.92 mmHg/sec | recovery 5 minutes |
| EFF(P)ᵣₑₛ/EFF(P)ₘₐₓ | 61% | rest |
| EFF(P)ᵣₑₛ/EFF(P)ₘₐₓ | 37% | stage 1: speed 3.3 mph, slope 5% |
| EFF(P)ᵣₑₛ/EFF(P)ₘₐₓ | 24% | stage 2: speed 3.3 mph slope 10% |
| EFF(P)ᵣₑₛ/EFF(P)ₘₐₓ | 8% | stage 3: speed 3.3 mph slope 15% |
| EFF(P)ᵣₑₛ/EFF(P)ₘₐₓ | 0% | maximal exertion |
| EFF(P)ᵣₑₛ/EFF(P)ₘₐₓ | 33% | recovery 2 minutes |
| EFF(P)ᵣₑₛ/EFF(P)ₘₐₓ | 51% | recovery 5 minutes |

Maximal reference frames SBP*ₘₐₓ of 600 mm Hg/sec and EF(P)ₘₐₓ of 60% for use in the instant invention were derived from the data at maximal exercise intensities SBP of 188 mm Hg, DBP of 79 mm Hg, as published by Allison in an article, entitled Maximal exercise blood pressure by age and gender Circulation 1988; 80:240-246 and heart rate of 197 l/min, as published by Wolthuis. Minimal reference frames SBP*ₘᵢₙ of 115 mm Hg/sec and EF(P)ₘᵢₙ of 30% for use in the instant invention were generated from data at rest for subjects of the age group of 20 years to 30 years, as published in Ciba-Geigy Scientific Tables, Ciba-Geigy Corporation, Medical Education Division, West Caldwell, N.J. 07006, ISBN 0-914168-54-1, 1990 of SBP equal to 115 mm Hg, DBP equal to 80 mm Hg, and HR equal to 60 l/min.

According to the instant invention, the area inscribed by maximal and minimal reference frames denotes the area of operation with finite sufficiency and efficiency and further the area outside of the reference frames denotes the area in which the system fails to perform because of insufficiency and inefficiency, thus, identifying the need for corrective action, when a task causes the operating point to be located beyond maximal or minimal reference frames, where no reserves exist, in order to return to sufficient and efficient operation.

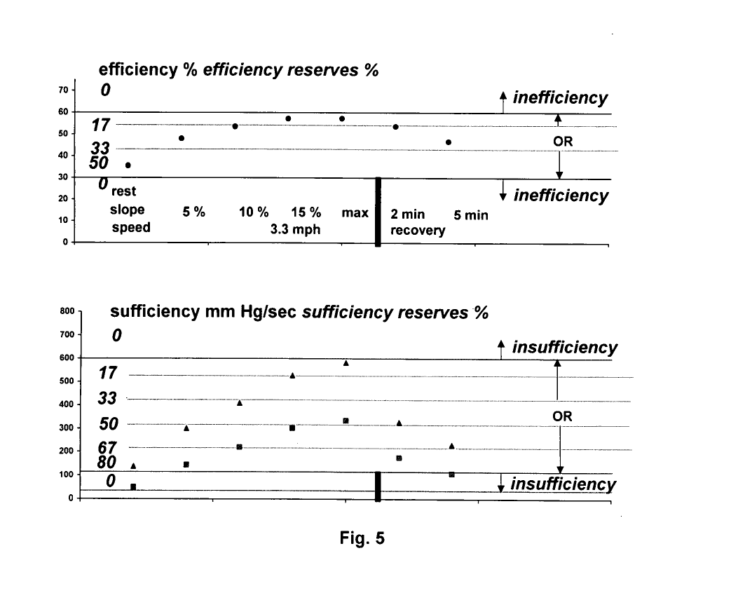

Reference is made to FIG. 5, where the instant invention is used to determine efficiency and sufficiency during the performance of various tasks of exercising at various increasing intensity levels and also during recovery, said efficiency and sufficiency further used to determine respective reserves. Here the instant invention is used to determine safe exercise levels by maintaining finite sufficiency and efficiency reserves and avoiding insufficiency and inefficiency.

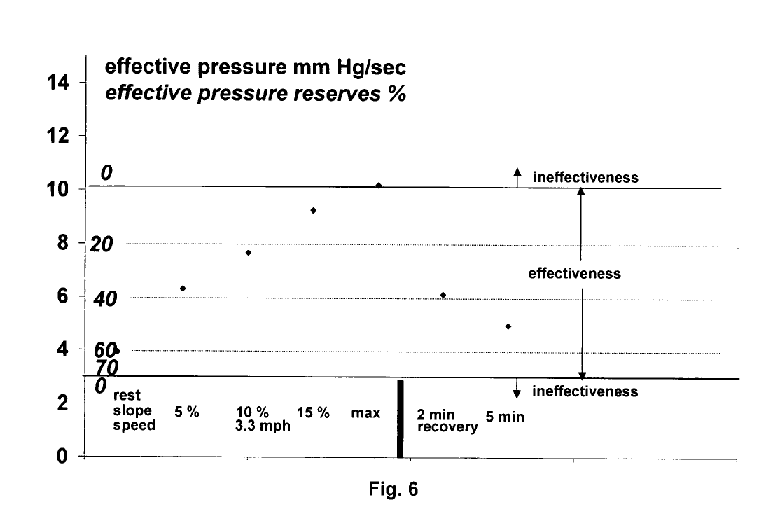

Reference is made to FIG. 6, to demonstrate utility of the instant invention to determine and display in an over-view, using one plot, effective pressure and effective pressure reserves during the performance of various tasks of exercising at various increasing intensity levels and also during recovery, for maintenance of effectiveness and avoidance of ineffectiveness, said ineffectiveness revealed by exceeding maximal and minimal thresholds.

In a further embodiment the instant invention can be practiced, using pulsatile, periodic signals during inflation and deflation of a blood pressure cuff, similar to the signals used in a graduated exercise test, said cuff signals being representative of various tasks performed such as pumping blood through restricted vessels during cuff inflation and pumping blood through relaxed vessels during deflation.

In another embodiment, if A₁* represents the monetary value of sales of things in time, A₂* the monetary value of the expenses incurred, then the instant invention has utility in management of a business by adjusting the location of the operating point, thus, monitoring sufficiency, efficiency, and effectiveness continuously and in real time.

In still another embodiment, if A₁ is the indicated horsepower, A₂ is the friction horsepower, as published by William H. Crouse and Donald L. Anglin on page 95 in a book, entitled Automotive Engines, McGraw Hill Company 1986, New York, USA ISBN 0-07-014957-7, then the instant invention has utility to determine engine performance and the need for engine maintenance.

In other embodiments of the present invention other parameters including but not limited to electrical, magnetic, mechanical, volume, area, pressure, optical, acoustic, thermal, transcendental parameters, including quantity of things, their monetary value, sales, expenses, and profits, also chemical parameters, further including oxygen concentration, oxygen consumption, also temperature signals, time, signals, frequency, heart rate, body surface area, body mass index, and also combinations thereof, further including energy, work, impedance, together with other constant parameters to serve as reference frames said parameters to be used to determine sufficiency, efficiency, effectiveness, deterioration, and improvement, to be further used to select interventions and to monitor improvement and/or deterioration, and to evaluate the benefits of the interventions.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather construed in breadth and scope in accordance with the recitation of the appended claims.

I claim:

1. A device for establishing performance of a system consisting of:
means responsive for measuring parameters of a system;
means responsive to the measurements of parameters;
means for providing performance equations of a system;
means for delineating the tasks of a system means for computing to derive performance from measured parameters, performance equations, and tasks;
means for establishing minimal and maximal reference zones of sufficiency, insufficiency, efficiency, inefficiency, and effectiveness in a performance diagram;
means for establishing an operating range in a performance diagram to accomplish a task;
means for determining an operating point in a performance diagram;
means for measuring reserves, effectiveness, deterioration and improvement in a performance diagram;
means for display of performance, sufficiency, efficiency, effectiveness, reserves, deterioration, improvement, and effectiveness in a performance diagram.

2. The performance measuring device according to claim 1 wherein said measurements of parameters include signals changing in time.

3. The device according to claim 1 wherein said means for deriving said performance diagram includes a computer for deriving performance from inputs of multiples of task-specific parameters via a keyboard, said reference frames are used to further establish zones of sufficiency, insuffiency, efficiency, inefficiency, effectiveness, ineffectiveness, reserves, operating range, and operating point, deterioration, and improvement of the system to accomplish of a task.

4. The device according to claim 3 wherein said means for establishing performance includes said computer for determining performance, according to
AA*=EF(A)×A₁*
AA*=A₁*−A₂*
EF(A)=(A₁−A₂)/A₁
A₁*=A₁/(t₁−t₂)
EF(A)ᵣₑₛ=EF(A)ₘₐₓ−EF(A)
EF(A)ᵣₑₛ/EF(A)ₘₐₓ=(EF(A)ₘₐₓ−EF(A))/EF(A)ₘₐₓ
A₁*ᵣₑₛ=(A₁*ₘₐₓ−A₁*)
A₁*ᵣₑₛ/A₁*ₘₐₓ=(A₁*ₘₐₓ−A₁*)/A₁*ₘₐₓ
EFF(A)=A₁*/EF(A)
EFF(A)ᵣₑₛ=EFF(A)ₘₐₓ−EFF(A)
EFF(A)ᵣₑₛ/EFF(A)ₘₐₓ=(EFF(A)ₘₐₓ−EFF(A))/EFF(A)ₘₐₓ
OR=((A₁*ₘₐₓ−A₁*)×(EF(A)ₘₐₓ−EF(A))
wherein AA*, A₁*, and A₂* equal AA, A₁, and A₂ referenced to time, and wherein A₁ is a parameter, measured at time t₁, A₂ is a parameter, measured at time t₂, and AA is the difference of A₁ and A₂, and wherein EF(A) denotes efficiency, A₁* denotes sufficiency, and EF(A)ₘₐₓ denotes the maximal efficiency reference frame, EF(A)ₘᵢₙ denotes the minimal efficiency reference frame, A₁*ₘₐₓ denotes the maximal sufficiency reference frame, A₁*ₘᵢₙ denotes the minimal sufficiency reference frame, EF(A)ᵣₑₛ denotes efficiency reserves, A₁*ᵣₑₛ denotes sufficiency reserves, EFF(A) denotes effictiveness, EFF(A)ᵣₑₛ, denotes effictiveness reserves, EFF(A)ₘₐₓ denotes maximal effectiveness frame, and EFF(A)ₘᵢₙ denotes minimal effectiveness frame, and OR the operating range

5. The device according to claim 4 wherein said computer measures performance, comprising sufficiency, efficiency, and effectiveness within the sufficiency reference frames, efficiency reference frames, and effectiveness reference frames of the performance diagram, wherein A₁*ₘᵢₙ<A₁*<A₁*ₘₐₓ determines sufficiency, EF(A)ₘᵢₙ<EF(A)<EF(A)ₘₐₓ efficiency, and EFF(A)ₘᵢₙ<EFF(A)<EFF(A)ₘₐₓ effectiveness, A₁*<A₁*ₘᵢₙ and A₁*>A₁*ₘₐₓ, insufficiency, EF(A)<EF(A)ₘᵢₙ and EF(A)>EF(A)ₘₐₓ, EFF(A)<EFF(A)ₘᵢₙ and EFF(A)>EFF(A)ₘₐₓ ineffectiveness.

6. The device according to claim 5 wherein said computer determines sufficiency reserves of the system A₁*ᵣₑₛ, from difference of A₁*ₘₐₓ and A₁*, efficiency reserves, EF(A)ᵣₑₛ, of the system from the difference of EF(A)ₘₐₓ and EF(A), and effectiveness reserves EFF(A)ᵣₑₛ of the system from the difference of EFF(A)ₘₐₓ and EFF(A) and deterioration, when sufficiency reserves, and/or efficiency reserves and/or effectiveness reserves decline over time, and improvement, when sufficiency reserves and/or efficiency reserves, and/or effectiveness reserves increase over time.

7. The device according to claim 6 to design and monitor system-specific interventions for improvement of sufficiency reserves, efficiency reserves and effectiveness reserves reserves.

8. The device according to claim 6 to determine the operating point of a system within the operating range and to design and monitor system-specific interventions for relocation of the operating point to accomplish a task.

9. The device according to claim 1 wherein said parameters include but not limited to electrical, magnetic, mechanical, volume, area, pressure, optical, acoustic, thermal, transcendental parameters, further including quantity of things, their monetary value, sales, expenses, profit, also chemical parameters, further including oxygen concentration, oxygen consumption, also temperature, time, signals, frequency, heart rate, body surface area, and body mass index, and still further combinations thereof, further including energy, work, and impedance.

10. The device of claim 6 wherein said means responsive to the measurement of said signals include appropriate apparatus sensitive to the signals, weight, height, body surface area, body mass index, pre-selected time intervals, and pre-selected minimal and maximal reference frames, and tasks to be accomplished, further catheters, electrodes, electrocardiographs, bioimpedance measuring equipment magnetic resonance measuring equipment, ultra-sound equipment, pressure transducers, pressure cuffs, temperature sensors, chemical sensors, time sensors, and echocardiographic sensors and additional means responsive to input representative of patient information including weight, height, body surface area, body mass index, pre-selected time intervals, and pre-selected minimal and maximal reference frames.

11. A method of diagnosing performance of a system; said method including the steps of:
measuring parameters A of said system at an initial time t₁, denoted A₁, and at a subsequent time t₂, denoted A₂;
establishing performance from the performance equations
AA*=EF(A)×A₁*
AA*=A₁*−A₂*
EF(A)=(A₁−A₂)/A₁)
A₁*=A₁/(t₁−t₂)
EF(A)ᵣₑₛ=EF(A)ₘₐₓ−EF(A)
EF(A)ᵣₑₛ/EF(A)ₘₐₓ=(EF(A)ₘₐₓ−EF(A))/EF(A)ₘₐₓ
A₁*ᵣₑₛ=(A₁*ₘₐₓ−A₁*)
A₁*ᵣₑₛ/A₁*ₘₐₓ=(A₁*ₘₐₓ−A₁*)/A₁*ₘₐₓ
EFF(A)=A₁*/EF(A)
EFF(A)ᵣₑₛ=EFF(A)ₘₐₓ−EFF(A)
EFF(A)ᵣₑₛ/EFF(A)ₘₐₓ=(EFF(A)ₘₐₓ−EFF(A))/EFF(A)ₘₐₓ
OR=((A₁*ₘₐₓ−A₁*)×(EF(A)ₘₐₓ−EF(A))
wherein AA*, A₁*, and A₂* equal AA, A₁, and A₂ referenced to time, and wherein A₁ is a parameter, measured at time t₁, A₂ is a parameter, measured at time t₂, and AA is the difference of A₁ and A₂, and wherein EF(A) denotes efficiency, A₁* denotes sufficiency, and EF(A)ₘₐₓ denotes the maximal efficiency reference frame, EF(A)ₘᵢₙ denotes the minimal efficiency reference frame, A₁*ₘₐₓ denotes the maximal sufficiency reference frame, A₁*ₘᵢₙ denotes the minimal sufficiency reference frame, EF(A)ᵣₑₛ denotes efficiency reserves, A₁*ᵣₑₛ denotes sufficiency reserves, EFF)A) denotes effictiveness, EFF(A)ᵣₑₛ, denotes effictiveness reserves, EFF(A)ₘₐₓ denotes maximal effectiveness frame, EFF(A)ₘᵢₙ denotes minimal effectiveness frame, and OR denotes the range of operation,
establishing a performance diagram;
establishing maximal and minimal reference frames in the performance diagram;
establishing a range of operation and an operating point;
comparing measured and derived performance data to the reference frames for computing sufficiency, efficiency and effectiveness, sufficiency reserves, efficiency reserves, and effectiveness reserves, determining deterioration and improvement from the time changes of declining or increasing reserves and display of said data in the performance diagram;

12. The method of claim 11 including the steps of design and monitoring of system-specific interventions for improvement of the reserves;

13. The method of claim 11 wherein said step of measuring includes parameters changing in time, to further include but not limited to electrical, magnetic, mechanical, volume, area, pressure, optical, acoustic, thermal, transcendental parameters, further including quantity of things, their monetary value, sales, expenses, profit, also chemical parameters, further including oxygen concentration, oxygen consumption, also temperature, time, signals, frequency, heart rate, body surface area, and body mass index, and still further combinations thereof, further including energy, work, and impedance.

14. The method of claim 11 wherein said means responsive to the measurement of said signals include appropriate apparatus sensitive to the signals, weight, height, body surface area, body mass index, pre-selected time intervals, and pre-selected minimal and maximal reference frames, and task to be accomplished, further catheters, electrodes, electrocardiographs, bioimpedance measuring equipment magnetic resonance measuring equipment, ultra-sound equipment, pressure transducers, pressure cuffs, temperature sensors, chemical sensors, time sensors, and echocardiographic sensors and additional means responsive to input representative of patient information including weight, height, body surface area, body mass index, pre-selected time intervals, and pre-selected minimal and maximal reference frames.
